(19) United States
(12) Patent Application Publication
(10) Pub. No.: US 2003/0119476 A1
(43) Pub. Date: Jun. 26, 2003

(54) Free mail delivery system

(75) Inventors: Yukinori Asada, Yokohama (JP); Koji Suzuki, Yokohama (JP); Kenichi Hamazaki, Yokohama (JP); Naoki Mori, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/122,477

(22) Filed: Apr. 12, 2002

(30) Foreign Application Priority Data
Oct. 17, 2001 (JP) 2001-319033

(51) Int. Cl. H04Q 7/20; H04M 11/00

(52) U.S. Cl. 455/406; 455/403

(57) ABSTRACT

A delivery system capable of sending mail for free to alleviate the burden of a connecting fee on the mail receiver.

A sender of free mail for reducing the burden of a receive connecting fee for the sent mail is registered in the server, and acquires an ID from the server. When sending mail, the registered sender of the free mail selects whether or not to bear (pay) the cost of the receive connection fee, or whether or not to pay a royalty to the mail receiver. The cellular telephone of the mail receiver displays whether or not the connection fee is free, and displays the amount if there is a royalty. The server bills the mail sender for the receive connection fee. Mail may also be automatically received when receiving free mail with no connection fee.

### BACKGROUND OF THE INVENTION

1. Technical Field of the Invention

The present invention relates to a mail distribution technology having a mail receive function and more particularly to a mail distribution technology for placing on the mail sender the burden of paying the connection fee billed to the cellular telephone user receiving mail when so desired by the mail sender.

2. Description of Related Art

Cellular telephones capable of connecting to the Internet, cellular telephones having mail functions for mutually exchanging electronic mail, and cellular telephones capable of selecting mail item names and mail text to be received have been invented in the related art. Further, technology capable of receiving mail appended with voice and image files on cellular telephones has been developed and these files can be sent or received on cellular telephones by utilizing this technology.

When cellular telephone mail and images can be received in this way, the amount of data that is sent increases and the interconnection fees also increase. A portion of the mail is private correspondence so the mail receiver agrees to pay the connection fee, probably seeing this type of mail as an unavoidable expense. However, payment for some types of mail should be the responsibility of the mail sender. Mail of this type for example includes advertising and public relations types of mail, mail relating to defects in products that were sold and countermeasures, and mail types for general announcements, etc. The annoying burden of paying connecting fees for this type of mail should not be placed on the mail receiver, however current mail delivery Systems are not configured to allow the mail sender to bear the burden of paying mail connection fees of mail sent to a mail receiver. Therefore, the mail receiver must pay connection fees for opening mail whose viewing was unnecessary.

Measures to cope with this problem include services to make the connection cost free up to a fixed amount of data or to automatically reject incoming calls from particular mail addresses however these kind of measures do not essentially resolve the problem.

Cellular telephone mail, the same as with computer mail is capable of simultaneously sending mail to large numbers of people. In computer mail in Japan, the data rate is large so the modem connection fee is small yet the connection fee for cellular telephone mail is relatively high (at the time of this application, 0.3 yen for mail of 128 letters in 1 packet, or several yen for 1 page of text). The burden on the receiver increases even further when voice or images are appended to the cellular telephone mail.

A business or company on the other hand sees the cellular telephone as an attractive medium for advertisements and public relations. Therefore many such businesses or companies would probably be willing to pay the connecting fees instead of the user, in order to have their advertising and public relations seen by others.

For example, software must be downloaded for improving the software of a newly sold cellular telephone. In such cases, the manufacturer of the cellular telephone must first announce the new software by some medium such as newspapers, television or radio yet the user may not notice this announcement. Further, even if the user is aware of the announcement, bringing the cellular telephone to a dealer and having the software replaced is tremendously inconvenient for the owner of the cellular telephone.

The cellular telephone manufacturer would greatly benefit if the improved software could be sent appended to the mail, and the user then access this mail to automatically input the improved software. The manufacturer would benefit by not having to undergo the effort and expense of making announcements over newspapers, radio and television, having to stock the improved software at many dealer's stores, and having to train employees and await the arrival of the customer. In this case, the improved software should be installed for free with the cellular telephone manufacturer taking responsibility, however the user has to pay a connection fee by receiving the mail with appended software, thus inconveniencing the user.

A system is therefore needed that is capable of letting the manufacturer bear responsibility for paying the connection fee, and also a system for paying royalties to express thanks or apologies for inconvenience caused, etc.

### SUMMARY OF THE INVENTION

The present invention therefore has the object of providing mail distribution technology capable of having the mail sender bear the burden of connection fees for mail sent to the mail receiver.

Another object of the present invention is to provide mail distribution technology capable of having the mail sender bear the burden of the connection fees for mail sent to the mail receiver and also for paying royalties.

To achieve the above object of the present invention, in a first mail delivery system of the present invention, the cellular telephone comprises a function to append and send information for bearing the burden of the receive connection fee for the sent mail.

In a second mail delivery system of the present invention, the cellular telephone comprises a function to enter the amount of the royalty to pay to the user.

In a third mail delivery system of the present invention, the cellular telephone comprises a function to display whether or not the mail receive connection fee for each piece of mail is free or not.

In a fourth mail delivery system of the present invention, the cellular telephone comprises a function to display a royalty amount when a royalty has been added to the mail that was sent.

In a fifth mail delivery system of the present invention, the cellular telephone automatically receives the free mail when the sent mail is free mail.

In a sixth mail delivery system of the present invention, a server comprises a memory section for storing the registered senders of free mail, an ID issue section for issuing ID to the registered senders, and a billing section for billing each receive connection fee or a lump sum to the registered sender when the mail is free.

In a seventh mail delivery system of the present invention, a server comprises a memory section for storing the registered senders of free mail, an ID issue section for issuing ID to the registered senders, and when paying royalties to the mail receiver, a paying section for paying the royalty to the account of the mail receiver or performing procedures to offset the royalty versus other receive fees.

An eighth mail delivery system of the present invention comprising: a server of the carrier, a cellular telephone of the sender having a mail address registered in the server as a registered sender of free mail, and a receiver cellular telephone, wherein the mail sender cellular telephone has a function to add information that the mail is free and send the mail, and the mail receiver cellular telephone has a function capable of displaying whether the mail is free or not, and the server has a function to bill the mail sender cellular telephone for the mail receive connection fee.

A ninth mail delivery system of the present invention comprising: a server of the carrier, a mail sender cellular telephone having a mail address registered in the server as a registered sender of free mail, and a receiver cellular telephone, wherein the mail sender cellular telephone has a function to add information on payment of royalty to the mail receiver and send the mail, and the mail receiver cellular telephone has a function to display the amount of the royalty, and the server has a function to bill the royalty to the mail sender cellular telephone.

### BRIEF DESCRIPTION OF THE DRAWINGS

FIG. 1 is a block diagram showing the first embodiment of the delivery system of the present invention.

FIG. 2 is a drawing showing the mail arrival report screen displayed when the cellular telephone receives mail.

FIG. 3 is a flowchart showing the operating process of the carrier's server.

FIG. 4 is a drawing showing another typical display of newly received mail on the cellular telephone.

FIG. 5A, FIG. 5B, FIG. 5C are drawings showing display screens for describing the cellular telephone functions when the mail sender is bearing the connection fee costs. FIG. 5A shows typical mail-related functions. FIG. 5B shows mail-writing functions. FIG. 5C shows a typical mail type.

FIG. 6 is a drawing showing an example of the mail service log in screen for the free mail registered user.

FIG. 7 is a drawing showing an example of the mail-writing screen.

FIG. 8 is a drawing showing an example of the transmit mail okay/reject screen for receive mail charges.

FIG. 9 is a chart showing the operating process of the delivery system of the present invention.

### DETAILED DESCRIPTION OF THE PRESENT INVENTION

The embodiments of the present invention are hereafter described while referring to the accompanying drawings.

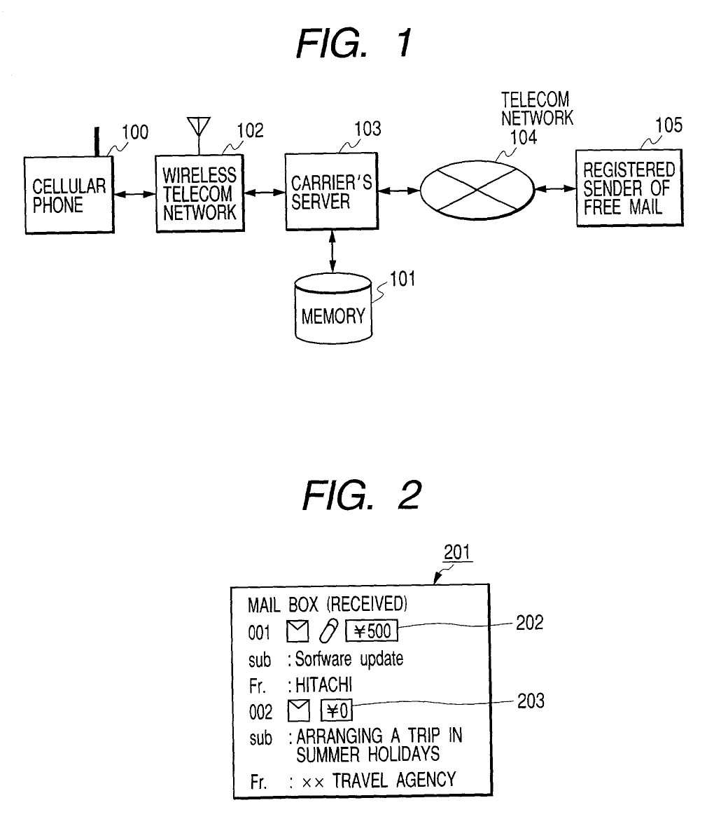

FIG. 1 is a block diagram showing the first embodiment of the delivery system of the present invention. In the figure, the name (company name, individual name) and mail address of the registered sender of free mail 105 or in other words, the mail sender bearing the burden of the mail receiver 's connection fee, are registered in the carrier's server 103 byway of a telecom network 104 such as a cellular telephone. This registration may be made by an application form sent by mail or by electronic mail from a personal computer. The registered name and mail address are stored in a memory 101 connected to the carrier's server 103. In this case, the carrier number may be assigned to the free mail registered sender when the name and mail address are registered. As can be seen, the burden of the mail receiver connection fee for mail sent from the registered sender of free mail by way of the cellular telephone carrier's server 103 can therefore be borne (paid). The connection fee can be billed to the registered sender of free mail 105, when the mail is sent to and received on the cellular telephone 100 via the wireless telecom network 102.

In this system, the connection fees for all mail from the mail address registered in the carrier's server 103 can be billed to the registered sender of free mail 105. Also, billing information, for example the burden of the receive connection fee or information for the receive connection fee and the burden of royalties for expressing thanks or inconvenience may be entered in the header of the mail sent from the registered sender of free mail 105, and then may be processed according to this billing information, in the cellular telephone carrier's server (hereafter simply called the server) 103. When accepting (paying) the mail connection fee instead of the mail receiver, the fee may be withdrawn from the account of the registered sender of free mail 105, and when paying royalties, the royalties may be deposited in the account of the mail receiver, and used to offset contract fees that the mail receiver must pay.

There are various possible methods for billing the registered sender of free mail 105 and examples are listed below.

(1) Bill the mail sending fee in advance to the registered sender of free mail 105 regardless of whether the mail was actually received by the mail receiver.

(2) Bill the registered sender of free mail 105 when the mail is received.

Besides the above, the method for billing the registered sender of free mail 105 must be decided after considering one or a combination of the following methods.

(1) Whether or not to collect a registration fee for registering the registered sender of free mail 105 in the server 103.

(2) Whether or not to collect a monthly basic service fee as the fee charged for providing the service by the server 103.

(3) Whether or not to collect a mail receiver connection fee included in the basic fee, according to the number of transmit destination mail addresses.

The following are possible services for the cellular telephone mail receiver as described previously.

(1) Making the connection fee (packet fee) required for receiving mail, free to the mail receiver (or mail user), and then sending that connection fee bill to the registered sender of free mail 105.

(2) Along with making connection fees free for the mail receiver, transferring royalties to the mail receiver to show thanks or apologies for inconvenience. Also, instead of paying royalties, the royalties can deducted from or used to offset the amount the mail receiver pays to the carrier's server.

A mail delivery report service may be utilized as a service for the registered sender of free mail 105, to show whether or not the mail user at the mail delivery destination received the mail. When mail whose connection fee is free is received, a report may be sent from the user confirming the mail was opened.

This mail delivery system may prove convenient if made available for individual use. In other words, a system allowing an individual cellular telephone user to accept connection fees for mail sent to another party. In this case, registration in the server 103 is the same as for a company. However when used by an individual, there are almost no cases where mail receiver connection fees for all mail sent from the registered mail address are accepted so in this case the billing information is input into the mail header, and the fact that the mail receive connection is being paid by the mail sender is made clear. An example of this service is described below.

(1) To send mail to another cellular telephone user, the mail sender selects accepting the mail connection fee for the other party and sends the mail to the other party.

(2) The mail receive report service is provided along with billing the mail sender's account for the other party's connection fees.

One possible application for this delivery system is to download debugged software from the cellular telephone manufacturer.

(1) The debugged software is automatically downloaded from the cellular telephone manufacturer and at no charge (free). Program writing (rewriting) then starts after the user confirms that it is okay to update the program.

(2) The debugged software is automatically downloaded from the cellular telephone manufacturer and at no charge (free). Updating is then automatically performed timed to when the cellular telephone power is off, when charging is off, or power is on.

The cellular telephone functions in response to the free mail service is next described using FIG. 2.

A typical mail delivery report displayed on the screen of the cellular telephone when mail was received is shown in FIG. 2. To utilize this system, the display must show whether or not to pay royalties for the received mail. In the figure, 201 is the mail (receive) box and 001 indicates there are attached files. The figure in the rectangular enclosure 202 shows the royalty when mail was received. In the case shown here, 500 yen was transferred as the royalty. In the figure, sub is the mail contents, and is a software update. Fr. in the figure, indicates the sender of the mail. 002 in the figure, indicates the second mail, and the 0 yen of the rectangular enclosure 203 indicates that the connection fee is free when the mail was received.

Mail whose connection is free in the list on the mail box 201 may also be shown by an icon. Also, the total royalty amount, for example the monthly amount of the royalty may be summed and the total shown. Further, free mail and royalty mail may be automatically downloaded and other mail can be downloaded by selecting it.

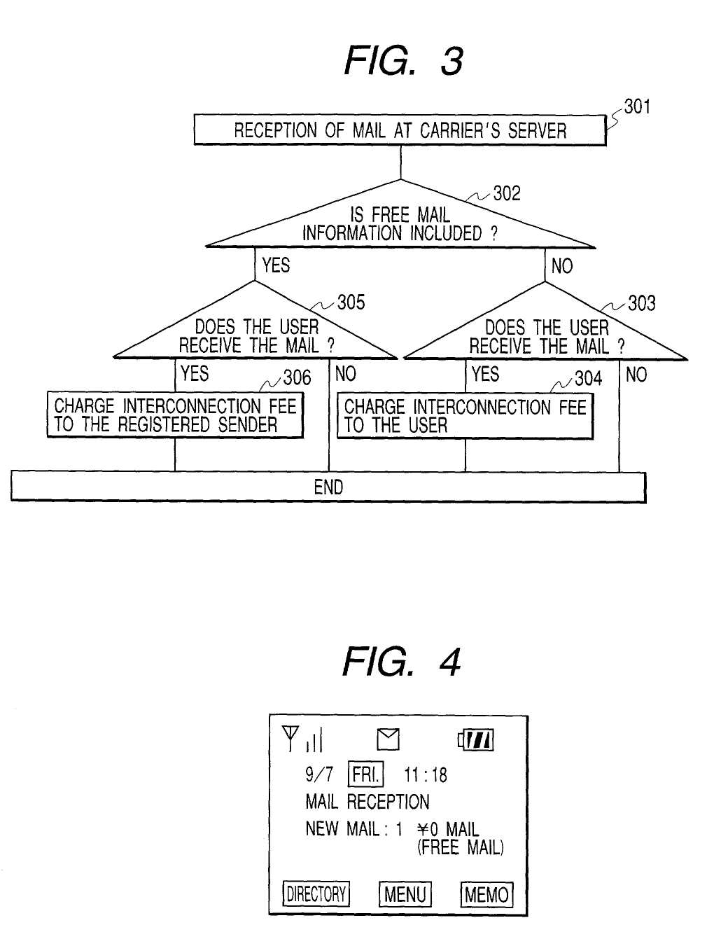

The processing in the cellular telephone carrier's server 103 is next described while referring to FIG. 3.

FIG. 3 is a flowchart showing an example of the processing of the carrier's server. In step S301, the mail is received at the carrier's server 103. Instep 302, whether or not information constituting free mail was added is determined. When not added with information showing free mail, then the user is billed a connection fee if the user received that mail. If the user does not receive that mail then there is no connection fee so the processing terminates. When determined in step 302 that information was added indicating free mail and if the user receives that mail in step 305, then in step 306 that mail connection fee is billed to the mail sender.

FIG. 4 is a plain view showing another typical display of newly received mail on the cellular telephone. The “new mail 0 yen: 1 item” shows that the connection fee is borne (paid) by the mail sender when the mail is received. An example when the cellular telephone of the present invention has a function for writing mail for free connection (receiving is free) mail is described next.

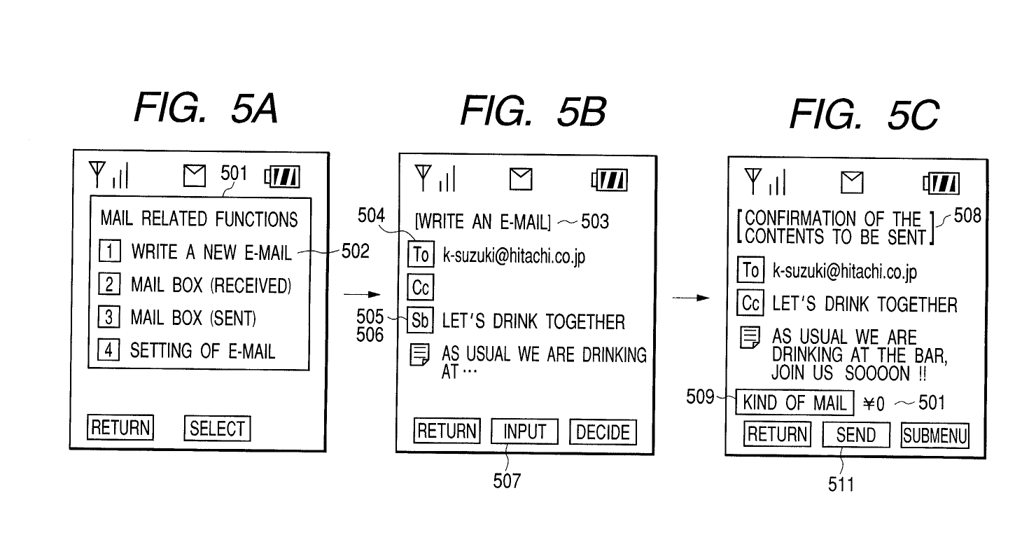

FIG. 5 is a plan view for describing the cellular telephone function when the mail sender bears (pays) the connection fee. FIG. 5A shows mail related functions. FIG. 5B shows mail write functions. FIG. 5C shows mail types. As shown in FIG. 5A, to write and send mail, “WRITE A NEW E-MAIL” 502, is selected from the mail related functions. The “WRITE AN E-MAIL” 503 screen appears when “WRITE A NEW E-MAIL” 502 is selected, so the mail address destination (To) 504, the message title (Sb) 505 and the message 506 are written, and when the “INPUT” button 507 is clicked, the “CONFIRMATION OF THE CONTENTS TO BE SENT” 508 screen appears, and along with displaying the destination, title and message, the “MAIL TYPE” 509 is also displayed. When 0510 yen is entered in this “MAIL TYPE” 509, the mail receiver connection fee is then borne (paid) by the mail sender. Pressing the “SEND” button 511 sends the mail.

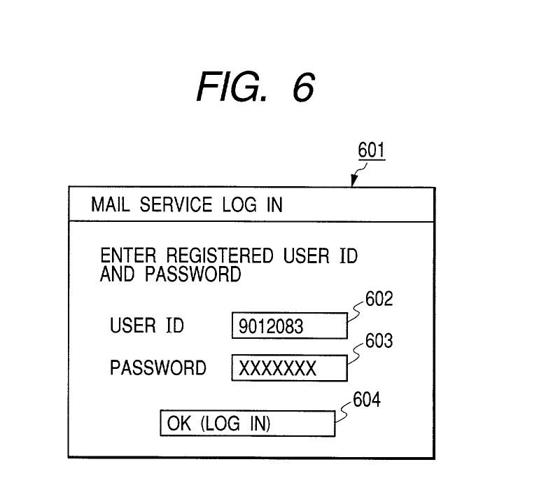

An example of the cellular telephone function when for example, a company pre-registered as a registered sender of free mail, sends free mail to a large number of people at one time is next described while referring to FIG. 6 through FIG. 8.

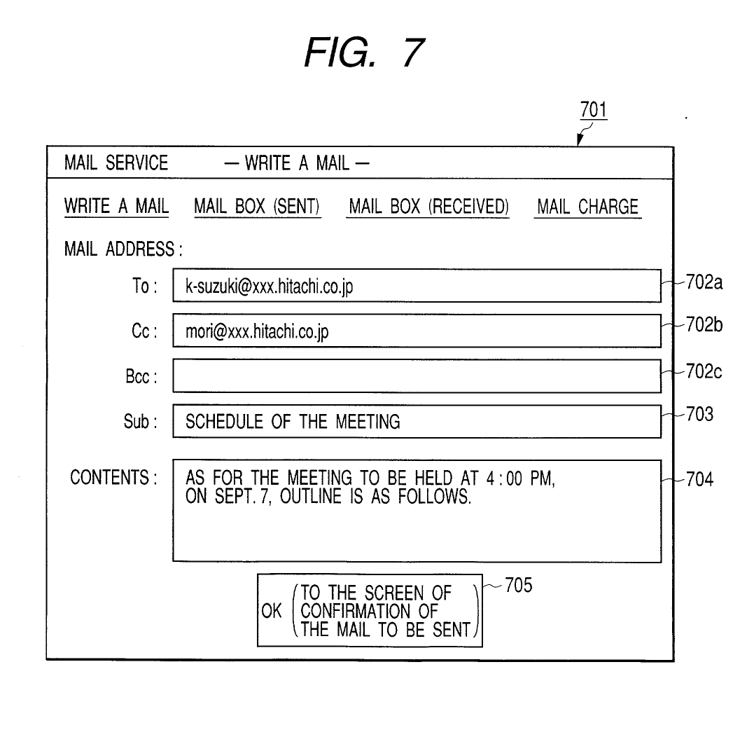

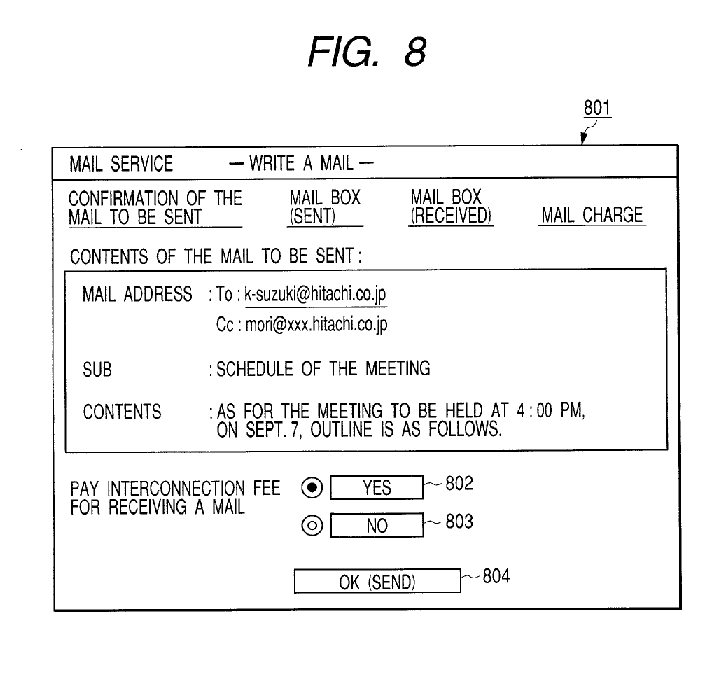

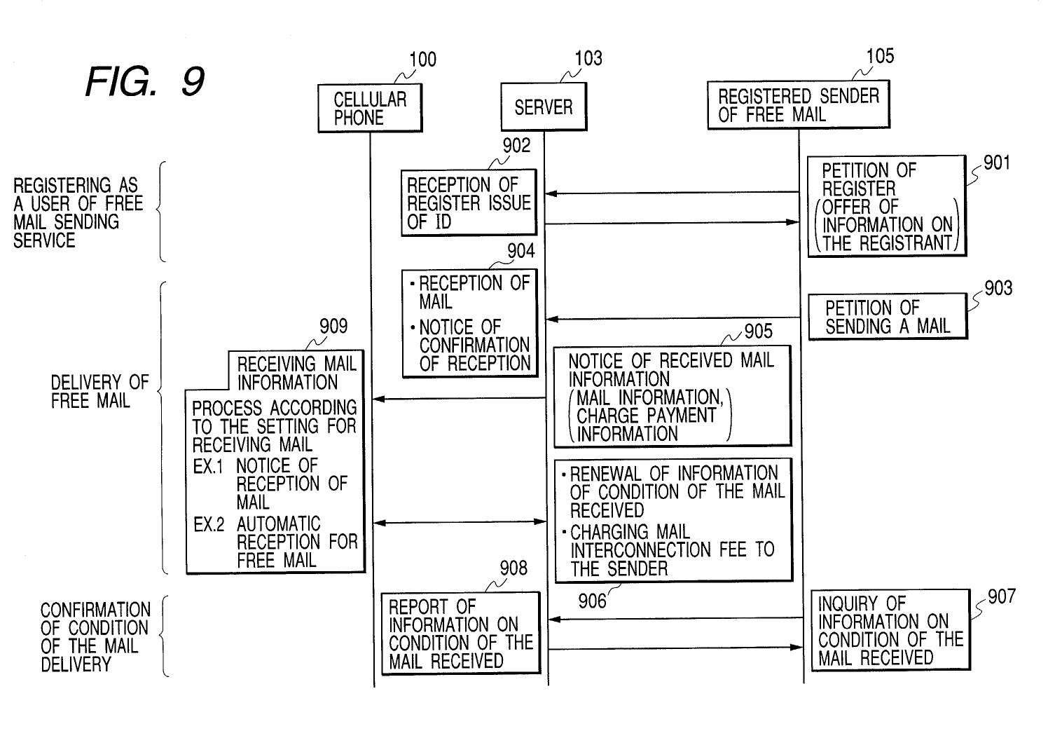

FIG. 6 is a plan view showing an example of the mail service log in screen for the free mail registered user. FIG. 7 is a plan view showing an example of the mail writing screen. FIG. 8 is a plan view showing an example of the sent mail okay/reject screen for the sender to accept mail charges for receiver mail.

In the figure, to send free mail, the registered sender of free mail 105 selects the Mail Service Log In screen 601 from the mail related function screen (not shown on drawing). The USER ID 602 and the PASSWORD 603 entry boxes then appear on the Mail Service Log In screen 601 so the information is entered in the USER ID 602 and the PASSWORD 603 entry boxes. The OK (LOG IN) button 604 is then clicked and the screen switches to the mail write screen 702 of FIG. 7. The required destination addresses are then entered in the mail addresses 702a through 702c, and the item name 703 and the text 704 are input. When the “OK (CONFIRMATION OF MAIL TO BE SENT)” 705 is clicked, the screen switches to the Confirmation of Mail To Be Sent screen 801 in FIG. 8. There is a Pay Interconnection Fee For Receiving Mail” box at the lower part of the Confirmation of Mail To Be Sent screen, so that either YES (will pay fee) 802 or NO (will not pay fee) 803 can be selected. In this embodiment, YES (will pay fee) 802 is selected. This mail is then sent when “OK (SEND)” 804 is clicked, and the connection fee is billed to the mail sender when the mail receiver receives this mail.

The operation for processing for the registered sender of free mail, the carrier's server, and the cellular telephone of this delivery system are next described while referring to FIG. 9.

FIG. 9 is a chart showing an example of the operating process of the delivery system of the present invention. In this figure, when registering for permission to send free mail, the name, mail address and other required information are appended and sent to the server in step 901. The server 103 accepts the registration and issues an ID in step 902. In step 903, when the registered sender of free mail 105 petitions the server 103 for sending of free mail, along with accepting the mail, a notice of mail confirmation is made in step 904. The server 103 reports the receiving of the mail in step 905. When the mail sender is paying the mail connection fee during receiving of the mail, or in other words, when free mail is being sent, the information making clear that the mail is free, is sent. When the mail information is received on the cellular telephone 100 in step 905, processing is performed according to the receive settings. For example, the notice of received mail information displays whether the mail is free or not, and displays the royalty that is paid if free mail was received. Processing may also be performed to automatically receive free mail.

When this processing is performed on the cellular telephone 100, the mail receive status is rewritten in step 906 when the mail is received, and processing performed to bill the free mail connection fee to the sender. In step 907 when the registered sender of free mail 105 inquires about mail receive conditions, the server 103 writes a receive condition report (or notice) and contacts the registered sender of free mail 105.

The present invention as related above is therefore capable of sending free mail and mail for paying royalties to the mail receiver. The connection fee required for the mail receiver to receive free mail is billed to the sender so that the mail receiver can receive free mail without having to pay for the connection fee. Further, in the case of royalty mail, that royalty can be paid to one's account by receiving that mail. The royalty can also be used to offset fees that must be paid to the carrier server for that cellular telephone.

Also, the free mail can be received automatically.

The present invention as described above is therefore capable of sending mail whose required receive connection fee is paid by the sender. Mail with royalties can also be sent.

Also, the information that the mail is free is displayed on the cellular telephone.

What is claimed is:

1. A cellular telephone capable of sending electronic mail, comprising;
a sending/receiving part of said electronic mail,
a controller connected to said sending/receiving part and having a function for adding information on paying said receive connection fee for mail that was sent, and
a display connected to said controller for displaying said electronic mail and said information.

2. A cellular telephone capable of sending electronic mail, comprising;
a sending/receiving part of said electronic mail,
a controller connected to said sending/receiving part and having a function for entering the amount of royalties to pay to said mail receiver, and
a display connected to said controller for displaying said electronic mail and said royalty amount.

3. A cellular telephone capable of sending electronic mail, comprising;
a sending/receiving part of said electronic mail,
a controller connected to said sending/receiving part and having a function for displaying whether said mail receive connection fee for each piece of mail is free or not, and
a display connected to said controller for displaying said electronic mail and displaying whether said mail receive connection fee is free or not.

4. A cellular telephone capable of sending electronic mail, comprising;
a sending/receiving part of said electronic mail,
a controller connected to said sending/receiving part and having a function for displaying said royalty amount, when a royalty was added to said mail that was sent, and
a display connected to said controller for displaying said electronic mail and said royalty amount.

5. A cellular telephone capable of sending electronic mail, comprising:
a sending/receiving part of said electronic mail,
a controller connected to said sending/receiving part and having a function to automatically receive said free mail when said mail that was sent is free mail, and
a display connected to said controller for displaying said electronic mail.

6. A server comprising:
a memory section to store said registered senders of free mail,
an ID issue section to issue ID to said registered sender of free mail, and
a billing section to bill said registered sender for each receive connection fee or a lump sum in the case of free mail.

7. A server comprising:
a memory section to store said registered senders of free mail,
an ID issue section to issue ID to said registered sender of free mail, and
a selection section to select making payment to the account of said mail receiver or select using said royalty amount to offset other receive fees; as methods for paying royalties to said mail receiver.

8. A delivery system comprising:
a cellular telephone carrier server,
a sender cellular telephone having a mail address registered as said registered sender of free mail in said server, and
a receiver cellular telephone,
wherein said sender cellular telephone has a function for adding and sending the information that said mail is free mail, and
said receiver cellular telephone has a function for displaying whether said information is free or not, and said server has a function for billing said mail connection fee to said sender cellular telephone.

9. A delivery system comprising:
a cellular telephone carrier server,
a sender cellular telephone having a mail address registered as said registered sender of free mail in said server, and
a receiver cellular telephone,
wherein said sender cellular telephone has a function for adding and sending the information that a royalty is paid to said mail receiver, and said receiver cellular telephone has a function for displaying the amount of said royalty, and said server has a function for billing said royalty to said sender cellular telephone.
